(19) United States
(12) Patent Application Publication
(10) Pub. No.: US 2022/0389855 A1
(43) Pub. Date: Dec. 8, 2022

(54) COMPACT PISTON VALVE

(71) Applicant: BONTAZ CENTRE R&D, MARNAZ (FR)

(72) Inventors: Stéphane Pascal PEROTTO, AYSE (FR); Julien SIXT, SEYNOD (FR); Benoît CHENEVARD, VIANA DO CASTELO (FR)

(21) Appl. No.: 17/775,579

(22) PCT Filed: Nov. 13, 2020
(86) PCT No.: PCT/FR2020/052072

§ 371 Date: May 9, 2022

(30) Foreign Application Priority Data
Nov. 15, 2019 (FR) 1912747

(51) Int. Cl. F01P 3/10; F16K 15/06

(52) U.S. Cl. CPC F01P 3/10; F16K 15/063

(57) ABSTRACT

A piston valve includes a body, a valve seat, an obturator in the form of a piston and a return spring. The body includes an envelope provided with at least one outlet orifice for the pressurised fluid, and an interior element that is attached in the envelope. The interior of the body carries the valve seat and provides the translational guidance of the obturator in the body. Furthermore, the interior element includes at least one window configured to guide the fluid from the valve seat towards the outlet orifice.

### TECHNICAL FIELD AND PRIOR ART

The present invention relates to a piston valve for controlling the circulation of a pressurised fluid, in particular in the automobile field.

In the automobile field, piston cooling nozzles for internal combustion engines are used for spraying a cooling fluid such as oil against the piston bottom, i.e. against the piston face external to the explosion chamber, or in a piston gallery specially provided for this purpose.

The piston cooling nozzles normally used are attached parts, secured to the engine casing and communicating with an orifice supplying cooling fluid.

A nozzle includes a body wherein a valve is mounted, and at least one tube attached to the body to orient the cooling liquid.

The nozzle may be of the screw valve type, i.e., it includes a screw provided with a bore wherein the valve is mounted, the screw being screwed directly into the engine block. In general, a subassembly carrying the tube or tubes is held between the head of the screw and the engine block. According to another type of nozzle, the nozzle includes an attachment plate that is secured to the engine block by means of an attached screw.

The valve controls the circulation of the pressurised cooling fluid towards the piston. When the pressure of the fluid reaches a certain pressure level, the valve opens and allows the fluid to pass through the valve, being sprayed towards the piston via the tube or tubes.

Ball valves and piston valves exist. Piston valves generally have better reactivity than ball valves.

A piston valve includes a body provided with a bore emerging at a first longitudinal end of the body and the second longitudinal end of which is closed off, one or more lateral openings emerging in the bore forming one or more oil outlet orifices. The emerging end of the bore is connected to a pressurised fluid source and the lateral opening or openings are oriented towards the zone towards which the fluid is wished to be brought. An obturator with a form that is cylindrical of revolution, referred to as a piston, is mounted in the bore and is able to move between an idle position wherein it prevents the flow of the fluid from the bore and the outlet orifice or orifices and a complete opening position, wherein circulation is allowed. The piston is returned to the idle position by a spring mounted under compression between the closed second end of the body and the piston.

The nozzle including such a piston valve has a length beyond the oil outlet orifice or orifices that is relatively great so as to allow release of the piston with respect to the valve seat and to the outlet orifice or outlet orifices, when the valve opens, which increases its space requirement in the engine.

### DESCRIPTION OF THE INVENTION

Consequently, an aim of the present invention is to offer a piston valve for a pressurised fluid circuit having a smaller space requirement.

The aim stated above is achieved by a piston valve including a body, a valve seat, an obturator in the form of a piston and a return spring. The body comprises an exterior body, forming an envelope, provided with at least one pressurised fluid outlet orifice, and an interior body forming a jacket that is attached in the envelope. The jacket carries the valve seat and provides translational guidance of the obturator in the body. Furthermore, the jacket includes at least one window configured for guiding the fluid from the valve seat towards the outlet orifice.

By means of the use of this jacket, it is possible to arrange the valve seat in an axial position very much upstream with respect to the oil outlet orifice, which makes it possible for the release of the piston to take place at least partly upstream of the outlet orifice. The length of the valve, in particular of the part thereof upstream of the outlet orifice, can then be reduced.

Furthermore, the body of the nozzle includes, on the same side as the outlet orifice for the pressurised fluid, a bottom in a single piece with the envelope, and all the components of the nozzle, i.e., at least the obturator and the jacket, are introduced into the envelope through an open end thereof opposite to the bottom, and through which the pressurised fluid is delivered to the nozzle. Which simplifies the nozzle and makes it more reliable.

Advantageously, the external body is manufactured by cold stamping and then re-machining, which makes it possible to reduce the quantity of material required and to increase the production rate, and the jacket is manufactured from plastics material directly by injection moulding. The manufacturing cost of the valve is therefore reduced. Furthermore, the mass of the valve can be reduced compared with the piston valve of the prior art.

In other words, a piston valve is produced comprising a composite body wherein the functions are distributed between an exterior part and an interior part. The external part fulfils the function of securing to the fluid circuit and the circulation of the fluid towards the outside of the valve, and the interior part fulfils the function of valve seat and of guidance for the obturator, and forms at least one fluid channel for the fluid from the valve seat to the valve outlet.

An object of the present invention is then a piston valve for a hydraulic or pneumatic circuit including a hollow body of longitudinal axis, a first longitudinal end of which is closed off by a bottom and a second longitudinal end of which is intended to be connected to a pressurised fluid source, including at least one fluid outlet orifice, a valve seat between the second longitudinal end of the body and the outlet orifice, an obturator having a form that is cylindrical of revolution, cooperating with the valve seat, and a spring for returning the obturator in abutment against the valve seat. The body includes an envelope at least partially forming the exterior of the body and an interior element at least partially forming the interior of the body and mounted in the envelope in fluid-tight contact with the envelope. The envelope includes the at least one outlet orifice and a vent, and the interior element includes a bore the interior face of which comprises a first part on the same side as the second longitudinal end of the body and a second part on the same side as the outlet orifice, the first part and the second part being connected at the valve seat. The second part provides the translational guidance of the obturator along the longitudinal axis and includes at least one window extending axially so as to form a channel for the fluid between envelope and the obturator enabling the fluid to flow in the first part as far as the outlet orifice when the obturator is detached from the valve seat.

Advantageously, the interior element is made from plastics material.

For example, the body includes a first fluid-tight contact between a first longitudinal end of the interior element and the bottom of the envelope, and a fluid-tight contact between a second longitudinal end of the interior element and a second longitudinal end of the envelope located at the second longitudinal end of the body.

In one example embodiment, the first fluid-tight contact is obtained by a cone-on-cone contact. In another example embodiment, the first contact is a planar abutment orthogonal to the longitudinal axis.

According to an additional feature, the first longitudinal end of the interior element can include at least one annular rim in contact with the bottom of the envelope.

The second contact may be a planar abutment contact normal to the longitudinal axis.

The spring is a helical spring, and the obturator may include a hollow body closed at an end intended to come into contact with the valve seat. A longitudinal end of the spring is mounted in the obturator. Advantageously, the bottom includes a recess housing another longitudinal end of the spring.

In one example embodiment, each window includes a zone facing an outlet orifice.

The piston valve may include n outlet orifices and n windows, n being greater than or equal to 1. The n outlet orifices may be piercings and each window may have a cross section close to or equal to the diameter of an outlet orifice.

In an advantageous example, the piston valve includes means of angular orientation between the envelope and the interior element, so that a zone of a window is facing an outlet orifice. The orientation means may include shapes on the envelope and the interior element cooperating so as to impose a given angular position on the interior element with respect to the envelope.

The interior element can be held in the envelope by crimping.

Another object of the present invention is a pressurised fluid circuit including a pressurised fluid source and at least one piston valve according to the invention connected by the first end thereof to the fluid source.

The circuit forms for example a hydraulic circuit of an internal combustion engine.

Another object of the invention is a nozzle for cooling a piston of an internal combustion engine including at least one piston valve according to the invention and at least one tube intended to guide the fluid from the outlet orifice towards the piston. The envelope may include an external thread for mounting in an engine block.

Another object of the present invention is a method for manufacturing a piston valve according to the invention, including:
the manufacture of the envelope;
the manufacture of the interior element;
the introduction of the interior element into the envelope from one end of the envelope intended to be the fluid entry; and
the immobilisation of the interior element in the envelope.

The envelope is for example produced by cold stamping and re-machining.

The interior element is advantageously produced by thermoplastic injection moulding.

The interior element may be immobilised in the envelope by crimping. Advantageously, during the crimping, the interior element is put under axial strain in the envelope.

### BRIEF DESCRIPTION OF THE DRAWINGS

The present invention will be understood better on the basis of the following description and the accompanying drawings, on which:

FIG. 1 is an exploded view of a piston valve according to one example embodiment,

FIG. 2A is a view in longitudinal section of the valve of FIG. 1 along a first cutting plane, the valve being in a closed state,

FIG. 2B shows the view of FIG. 2A, the valve being in an open state,

FIG. 3 is a view in longitudinal section of the valve of FIG. 1 along a second cutting plane orthogonal to the first cutting plane, the valve being in an open state,

FIG. 4 is a perspective view of the interior element of FIG. 1 shown alone,

FIG. 5 is a view in longitudinal section of a piston valve according to another example embodiment, the valve being in a closed state,

FIG. 6 shows the piston valve of FIG. 5 in an open state,

FIG. 7 is a detail view of FIG. 6,

FIG. 8 is a perspective view of the interior element of FIG. 5 shown alone,

FIG. 9 is a view in longitudinal section of a piston valve according to another example embodiment, the valve being in a closed state,

FIG. 10 shows the piston valve of FIG. 9 in an open state,

FIG. 11 is a detail view of FIG. 10,

FIG. 12 is a perspective view of the interior element of FIG. 9 shown alone,

FIG. 13 is a view in longitudinal section of a piston valve according to another example embodiment, the valve being in a closed state,

FIG. 14 shows the piston valve of FIG. 13 in an open state,

FIG. 15 is a detail view of FIG. 14,

FIG. 16 is a perspective view of the interior element of FIG. 13 shown alone,

FIG. 17 is a view in longitudinal section of a piston valve according to another example embodiment, the valve being in a closed state,

FIG. 18 shows the piston valve of FIG. 17 in an open state,

FIG. 19 is a detail view of FIG. 18,

FIG. 20 is a perspective view of a part of the interior element of FIG. 18,

FIGS. 21A and 21B are perspective views of another part of the interior element of FIG. 18,

FIG. 22A is a perspective view of an example of a nozzle including a piston valve according to the invention,

FIG. 22B is a view in longitudinal section of the nozzle of FIG. 22A,

FIG. 23A is a perspective view of an example of a nozzle including a piston valve according to the invention,

FIG. 23B is a view in longitudinal section of the nozzle of FIG. 23A,

FIG. 24A is a perspective view of an example of a nozzle including a piston valve according to the invention,

FIG. 24B is a view in longitudinal section of the nozzle of FIG. 24A.

### DETAILED DESCRIPTION OF THE EMBODIMENTS

The invention will be described more particularly in an application to the cooling of a piston of an internal combustion engine of a motor vehicle by spraying cooling liquid. It will be understood that the invention applies to any hydraulic circuit, and also to any pneumatic circuit, in the automobile field and in other fields using pressurised fluids.

The invention relates to a piston valve, also referred to as a distributor, intended in particular for equipping nozzles, for example nozzles of the screw valve type, more particularly used in the field of cooling an internal combustion engine piston.

In all the example embodiments, the flow of the fluid is shown schematically by the arrows F.

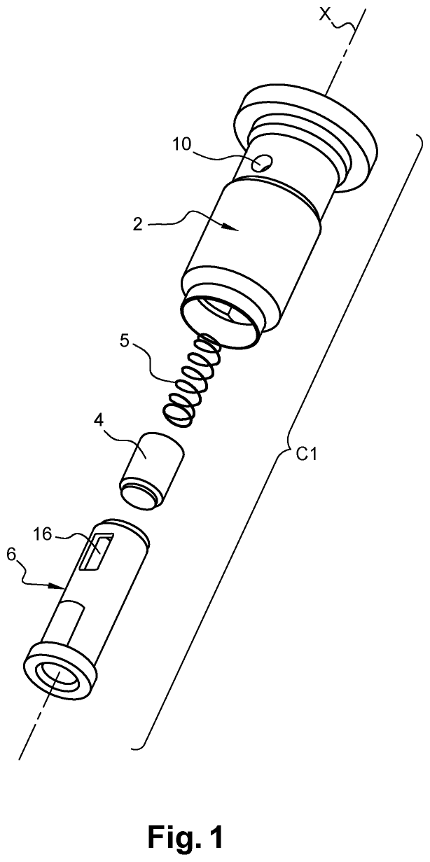

In FIGS. 1 to 4, a first example of a piston valve C1 including a body 2 can be seen. The body may include an external thread then forming a screw, enabling it to be mounted directly in the device to be equipped, for example in the engine block of the internal combustion engine.

The valve also includes an obturator 4 cooperating with a valve seat, a return spring 5 mounted between the obturator 4 and the body 2 pushing the obturator towards the valve seat. The obturator 4 has a shape that is cylindrical of revolution and can be referred to as a piston. It includes at least one longitudinal end intended to cooperate in a fluid-tight manner with the valve seat, and a lateral wall providing, during the sliding of the piston, fluid-tightness between the piston and the interior wall of the body 2.

The body 2 has a form that is substantially tubular of revolution of longitudinal axis X, comprising a first longitudinal end 2.1 and a second longitudinal end 2.2.

The body 2 includes an exterior body 3 or envelope and an interior body 6 referred to in the remainder of the description as “interior element”.

The envelope 3 includes a bore 8 emerging at the second longitudinal end 2.2 of the envelope. The other longitudinal end of the envelope is closed by a bottom 7. However, a vent 9 is formed in the bottom of the envelope to allow circulation of air when the obturator 4 moves.

The first end 8.1 of the bore 8 is oriented on the same side as the bottom of the envelope 3 and the second end 8.2 of the bore is oriented on the same side as the open end of the envelope 3. The bottom 7 is produced in a single piece with the envelope.

The second end 8.2 of the bore 8 is intended to be connected to a pressurised fluid source. The fluid flows from the second end 8.2 towards the first end 8.1.

The envelope 3 includes at least one fluid outlet orifice 10 passing through the lateral wall of the envelope. In the example shown, two diametrically opposed outlet orifices 10 are formed. The orifice or orifices emerge in the bore 8. The envelope is preferably produced from metal material, advantageously by cold stamping followed by re-machining to produce the bore 8 and the outlet orifices 10. It will be understood that the envelope may include more than two outlet orifices distributed in the circumference of the envelope.

The interior element 6 is intended to form a longitudinal guide surface for the piston as well as a valve seat.

The interior element 6 has a tubular form substantially of revolution about an axis X1 that is intended to be coaxial with the axis X when the interior element 6 is mounted in the envelope 3. The interior element 6 includes a first longitudinal end 6.1 and a second longitudinal end 6.2. The first longitudinal end 6.1 is intended to be inserted first in the bore 8 of the envelope 3 so as to be opposite the bottom of the envelope 3. The second longitudinal end 6.2 is disposed on the same side as the open end of the envelope 3.

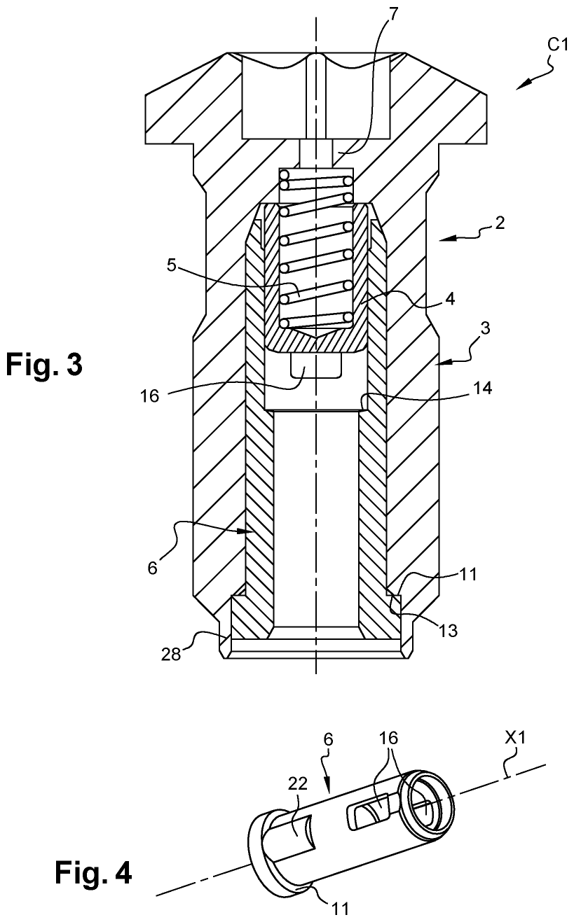

In FIGS. 3 and 4, the interior element can be seen, including, at its second longitudinal end 6.2, a shoulder 11 intended to come into contact with an annular surface 13 located at the second end of the bore 8. The annular surface 13 is for example produced by countersinking. The contact between the shoulder 11 and the annular surface 13 is such that it is fluid-tight. In a variant, the shoulder 11 and the annular surface form a cone-on-cone abutment. In a variant again, the interior element does not have a shoulder 11 and the fluid-tight contact between the interior element and the bore takes place at the end 6.2.

Advantageously, the interior element 6 is guided in the bore 8. The guidance can be provided by the ring carrying the shoulder 11 in cooperation with the portion of the bore including the annular surface 13, and/or by the cooperation of the exterior surface of the interior element 6 and the portion of the bore 8 upstream of the windows, considering the cross section in FIG. 3, or even by the cooperation of the entire exterior surface of the interior element 6 and of the bore 8.

The interior element 6 also includes a bore 12 of axis X1 and emerging at the two longitudinal ends of the interior element 6.

In the example shown, the bore 12 includes a portion with a smaller diameter 12.1 and a portion with a larger diameter 12.2 connected by an annular surface forming a valve seat 14 for the obturator 4. The outside diameter of the obturator 4 is such that it can slide longitudinally in the portion with the larger diameter 12.2 while being guided by the portion with the larger diameter 12.2.

The interior element also includes at least one lateral window 16, two windows in the example shown, emerging in the portion with the larger diameter 12.2 of the bore 12, i.e., downstream of the valve seat. The windows 16 are diametrically opposed and are positioned so that, when the interior element 6 is mounted in the envelope 3, a part of a window 16 is facing an outlet orifice 10.

The windows 16 have a first longitudinal end 16.1 on the same side as the first end 6.1 of the interior element 6, and a second longitudinal end 16.2 on the same side as the valve seat 14.

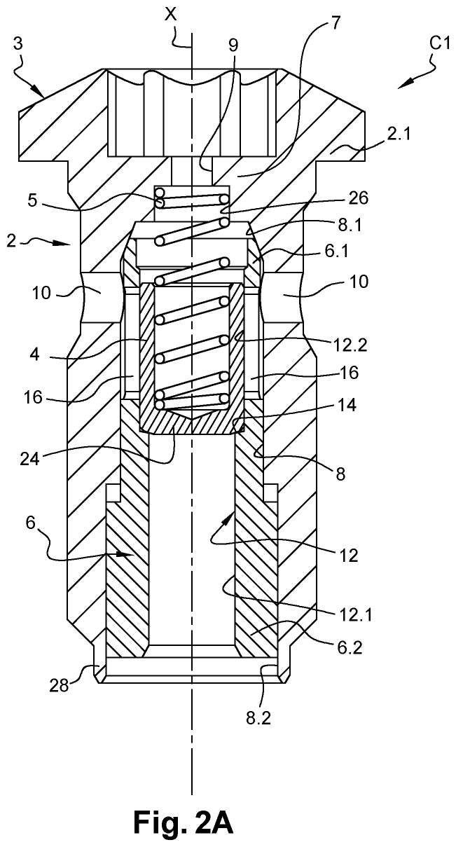

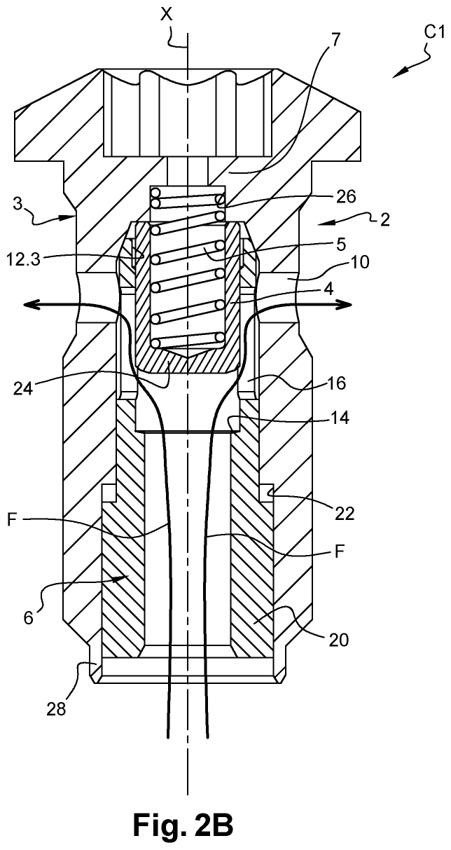

The first end 16.1 of each window is substantially opposite an outlet orifice 10 and the second end of each window is located just downstream of the valve seat 14 in the direction of flow F. As can be seen in FIG. 2A, each window 16 delimits, between the surface of the bore 8 and the exterior lateral surface of the obturator, a longitudinal channel that makes it possible to guide the pressurised fluid from the portion with the smaller diameter 12.1 of the bore 12 to an outlet orifice 10 via a passage between the envelope 3 and the lateral wall of the obturator 4. The use of the interior element 6 therefore makes it possible to increase the axial distance between the valve seat 14 and the outlet orifice or orifices 10. Thus, the space required for releasing the obturator when the valve opens is located upstream of the outlet orifices 10 in the direction of flow. The length of the envelope 3, in particular its axial extension downstream of the outlet orifices 10, can be reduced while not modifying the position of the outlet orifices. This reduction in length highly advantageously makes it possible to reduce the space requirement in the engine.

Advantageously, the transverse dimension of the window is equal to the diameter of the outlet orifices 10, so as to maximise the flow rate of fluid through the valve and to reduce the pressure drops. The windows 16 being relatively narrow, sufficient material remains for guiding the obturator 4.

Preferably, the exterior element 6 includes as many windows 16 as the envelope 3 includes outlet orifices 10.

In this example the windows 16 are rectangular in shape but other shapes can be envisaged, for example a trapezoidal shape.

Preferably, the valve includes orientation means 18 for angularly orienting the interior element 6 with respect to the envelope 3 around the longitudinal axis X so that, on assembly, each window 16 is directly opposite an outlet orifice 10, making it possible to optimise the flow rate through the valve.

In this example, the orientation means are formed both in the envelope and in the interior element. The interior surface of the bore 8 includes, at its second end 8.2, two grooves 20 extending longitudinally over a part of the surface. The interior element 6 includes, on its exterior surface, at its second longitudinal end 6.2, two ribs 22 extending longitudinally over a part of the length of the interior element and sized to enter the grooves 20. The ribs 22 are disposed with respect to each other in a manner corresponding to the relative arrangement of the two grooves 20. Thus, by orienting the interior element with respect to the envelope so as to align the grooves 20 and the ribs 22, each window 16 is automatically aligned with an outlet orifice 10. The length of the ribs is advantageously less than that of the grooves to ensure contact between the annular surface 13 and the shoulder 11.

In this example, each rib 22 is aligned with a window 16, but this arrangement is not limitative, it is possible to envisage ribs offset angularly with respect to the windows, for example by an angle of 90°.

The use of a groove and a rib or of more than two grooves and two ribs is not departing from the scope of the present invention. In a variant, the rib or ribs are carried by the envelope and the groove or grooves are carried by the interior element.

Other means such as visual markings on the envelope and the interior element can be envisaged to facilitate the orientation of the interior element with respect to the envelope.

In a variant, the windows 16 are not oriented with respect to the outlet orifices and an annular channel in which the windows and the outlet orifices emerge provides the flow of the liquid inside the interior element towards the outlet orifice whatever the orientation of the windows with respect to the outlet orifice. The channel may be produced for example by producing a portion of the bore 8 with the larger diameter at the outlet orifices 10 and/or a section of the interior element 6 at the window 16 with reduced diameter.

The first end 6.1 of the interior element 6 is such that its contact with the first end 8.1 of the bore 8 is substantially fluid-tight. Thus the outlet orifices 10 and the vent 9 are isolated from each other in a fluid-tight manner.

In this example, the first ends 6.1 and 8.1 are conformed to produce a cone-on-cone contact, providing a fluid-tight assembly. In a variant, a tight assembly of two cylindrical surfaces is not departing from the scope of the present invention.

The return spring 5 is mounted in reaction between the obturator and the bottom of the bore 8 so as to return the obturator in abutment against the valve seat 14.

In the example shown and preferably, the spring is a helical spring.

Advantageously, the obturator 4 includes a hollow body closed at a longitudinal end by a bottom 24 intended to cooperate with the valve seat, the spring 5 is mounted in the hollow body. The outside diameter of the spring 5 is less than the inside diameter of the hollow body. Furthermore, the bottom of the bore 8 also includes a recess 26 the inside diameter of which corresponds to the outside diameter of the spring 5 and forms a housing for the other end of the spring 5. The bottom of the bore 8 surrounding the recess advantageously forms an axial stop for the valve and preventing the spring from being compressed in a state where the turns would be contiguous. The vent 9 preferably emerges in the bottom of the recess 26.

Advantageously, the first end 12.3 of the bore 12 includes a surface left clear with respect to the outside diameter of the obturator that extends, making it possible to ensure free sliding of the obturator in the interior element despite the tight mounting of the interior element in the envelope.

The interior element 6 is immobilised longitudinally in the envelope 3, so that its first longitudinal end 6.1 is in tight contact with the first end 8.1 of the bore 8 of the envelope, and the shoulder 11 is in abutment against the annular surface 13. In the example shown and non-limitatively, the immobilisation is achieved by crimping. For this purpose, the envelope includes at its open end an annular projection 28 bordering the second end 8.2 of the bore 8 located upstream of the annular surface 13, and which is intended to be folded over the interior element to immobilise it axially (in the figures the projection 28 is not folded over). Preferably, the crimping is such that it puts the interior axial element 6 under axial strain to ensure fluid-tight contact between the conical surfaces of the envelope and of the interior element, and between the shoulder 11 and the annular surface 13. In the case where the interior element does not include a shoulder, the axial strain is applied between the end 6.1 of the interior element and the first end 8.1 of the bore 8.

The interior element 6 is advantageously produced from plastics material, preferably from thermoplastics material, preferably by moulding, preferably by injection moulding. The part obtained directly by injection moulding can be directly mounted in the envelope 3. By way of example the material of the interior element is selected from PA6.6 (polyamide 66), PPA (polyphthalamide), polyphenylene sulfide or PPS, PEEK (polyether ether ketone). Advantageously, an additive may be added, improving the sliding, for example PTFE (polytetrafluoroethylene) or graphite.

The interior element 6 may be produced from plastics material since it is not subjected to impacts or clamping forces liable to damage it.

The materials used for producing the envelope 3, the interior element 6 and the obturator 4 are selected according to the specification in terms of resistance to torque, to temperature, chemical resistance to the fluid circulating in the valve, in terms of coefficient of friction, in particular between the obturator and the interior element, to avoid premature wear and detachment of particles.

The envelope may for example be produced from forged steel, quenched or not, and the obturator may be produced from steel, aluminium or plastics material.

The longitudinal guidance of the obturator is obtained by the interior element.

An example of a method for manufacturing the valve C1 will now be described.

The envelope is produced by cold stamping. Then the part is re-machined, in particular to produce the bore 8 and the outlet orifices 10.

Moreover, the interior element is produced by injection moulding.

The obturator is for example produced by cold stamping, by plastic injection or by machining.

The obturator is housed in the portion with the larger small diameter 12.2 of the bore 12 of the interior element 6 and the spring is introduced into the obturator through a longitudinal end.

The assembly thus formed is next introduced into the bore 8 by introducing the first end 6.1 of the interior element 6 into the bore 8. The first end 6.1 comes into conical abutment against the conical surface of the bottom of the bore 8.

A crimping next takes place. This consists in deforming the annular projection 28 towards the interior element so as to hold the conical abutment between the end 6.1 and the end 8.1 of the bore 8.

In a variant, the interior element 6 and the body 2 can be assembled by butt crimping, i.e. by means of a punch that tears away the material in the bore 8 to hold the element 6, or by means of a claw washer.

The use of an envelope and of a bottom in a single piece and advantageously of crimping at the pressurised fluid inlet makes it possible firstly to reduce the number of components, simplifying manufacture, and secondly to substantially improve the security of operation of the nozzle. This is because, the bottom being in a single piece with the envelope, there is no risk of failure of crimping between the envelope and the bottom. If the crimping at the pressurised fluid inlet is faulty, the oil is always sent towards the tube of the nozzle. Finally, the action of the pressurised fluid tends to hold the components in the body of the nozzle and to keep them assembled, which enables them to continue to provide degraded operation of the nozzle.

On the other hand, in the nozzles of the prior art, such a bottom is crimped onto the body of the nozzle, and in the event of failure the components of the nozzle are then in the engine, ejected by the pressure of the fluid, which may damage the engine, and the fluid is no longer conducted towards the tube of the nozzle, which causes damage to the piston and failure of the engine. In addition, a very significant leakage of fluid results therefrom, causing a drop in a general fluid pressure of the engine, causing serious malfunctioning.

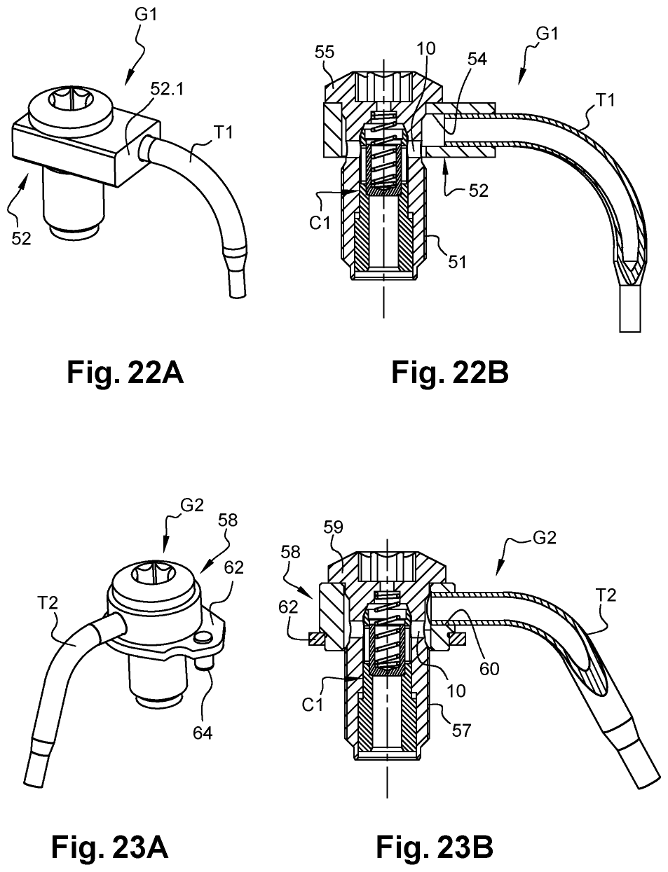

In FIGS. 22A, 23 and 24B various examples of a nozzle including a piston valve according to the invention can be seen.

In FIGS. 22A and 22B, the nozzle G1 is of the screw valve type, includes a piston valve C1 provided with an external thread 51 forming a screw, a body 52 mounted around the piston valve, a tube T1 mounted in a bore 54 of the body 52. The bore 54 emerges opposite at least one outlet orifice 10. The body is intended to be held by clamping between the head 55 of the screw and the engine block (not shown). Advantageously the body 52 includes means cooperating with means of the engine block to provide the orientation of the tube. In this example, the body includes a planar face 52.1 cooperating with a milling or a countersink produced on the engine block.

In FIGS. 23A and 23B, the nozzle G2 is also of the screw valve type and includes a piston valve C1 provided with an external bore 57 forming a screw, a body 58 in the form of a ring, a tube T2 mounted in a bore 60 of the body 58. The bore 60 emerges opposite at least one outlet orifice 10. The body 58 is intended to be held by clamping between the head 59 of the screw and the engine block (not shown). The nozzle also includes a mounting plate 62 and a pin 64 for orienting the nozzle. The pin is intended to enter an orifice formed in the engine block.

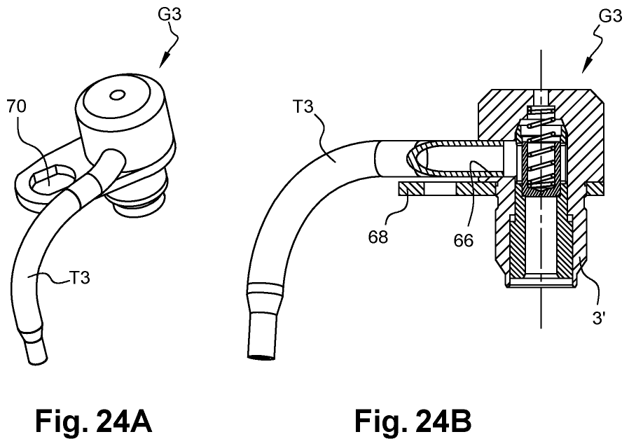

In FIGS. 24A and 24B, the nozzle G3 includes a piston valve of the single-piece type, the envelope 3′ of which forms the body provided with an extending bore 66 forming the outlet orifice 10 and a tube T3 mounted in a bore 66. The nozzle also includes a mounting plate 68. An aperture 70 is formed in the mounting plate 68 intended to receive a screw for securing to the engine block. The nozzle is for example formed by a fabricated assembly.

The nozzle may include a plurality of tubes.

The operation of a nozzle including a piston valve of FIG. 1 will now be described.

The nozzle is mounted in an engine case of an internal combustion engine, the tube or tubes being oriented so that the jet of oil is oriented towards the piston bottoms. The nozzle regulates the flow rate.

The pressure at which the valve opens depends on the load of the spring 5. As long as the force exerted by the pressurised oil on the obturator 4 is lower than the load of the spring 5, the obturator 4 rests on the valve seat 14 and the oil does not supply the outlet orifices (FIG. 1).

When the pressure is sufficient, the obturator detaches from the valve seat 14 and the oil circulates in the windows 16 and reaches the outlet orifices through which it is sprayed against the pistons of the engine.

When the pressure level increases, the obturator 4 comes into abutment against the bottom of the envelope 3 before the spring 5 is in a configuration with contiguous turns, which reduces the risks of damage thereto (FIGS. 2 and 3).

When the pressure passes below the given pressure, the obturator 4 is pushed against the valve seat 14 by the return spring 5, and the flow is interrupted.

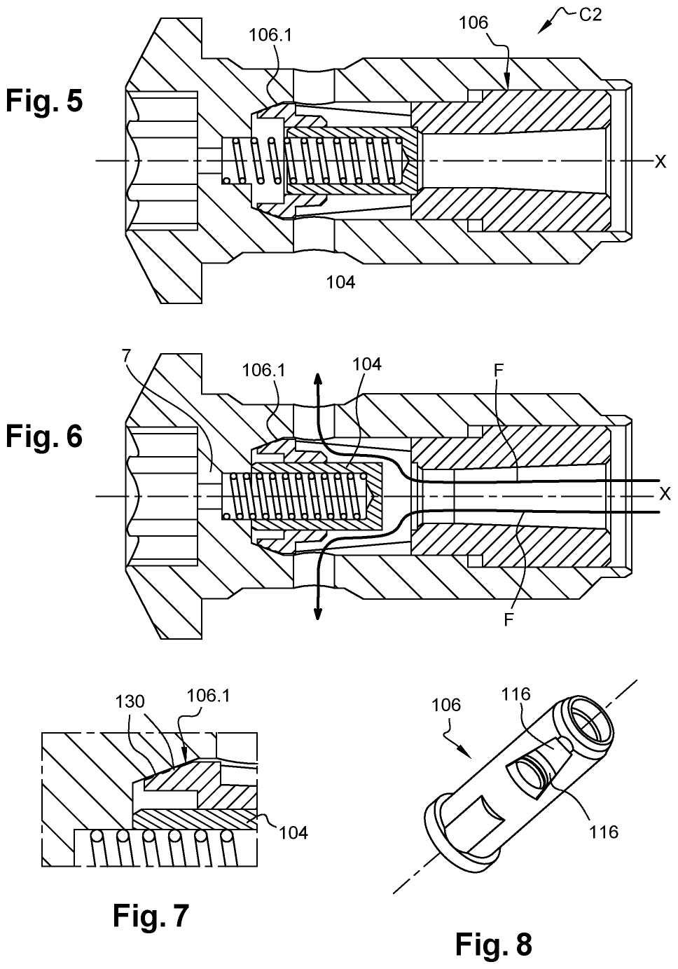

In FIGS. 5 to 8, another example of a piston valve C2 can be seen.

The valve C2 has a structure similar to that of the valve C1.

However, the valve C2 includes an obturator 104 the cross section of which has a smaller cross section, which makes it possible to maximise the cross section of flow of the oil and therefore the flow rate passing through the valve. Furthermore, the interior element 106 includes a conical surface at its first longitudinal end 106.1 provided with a plurality of annular rims 130 (FIG. 7) centred on the longitudinal axis and providing the fluid-tightness. These rims form zones that will deform at the time of assembly, in particular during crimping.

Furthermore, the windows 116 have trapezoidal shapes with the largest base oriented upstream (FIG. 8). This shape also participates in maximising the flow rate.

The operation of the piston valve C2 is similar to that of the valve C1.

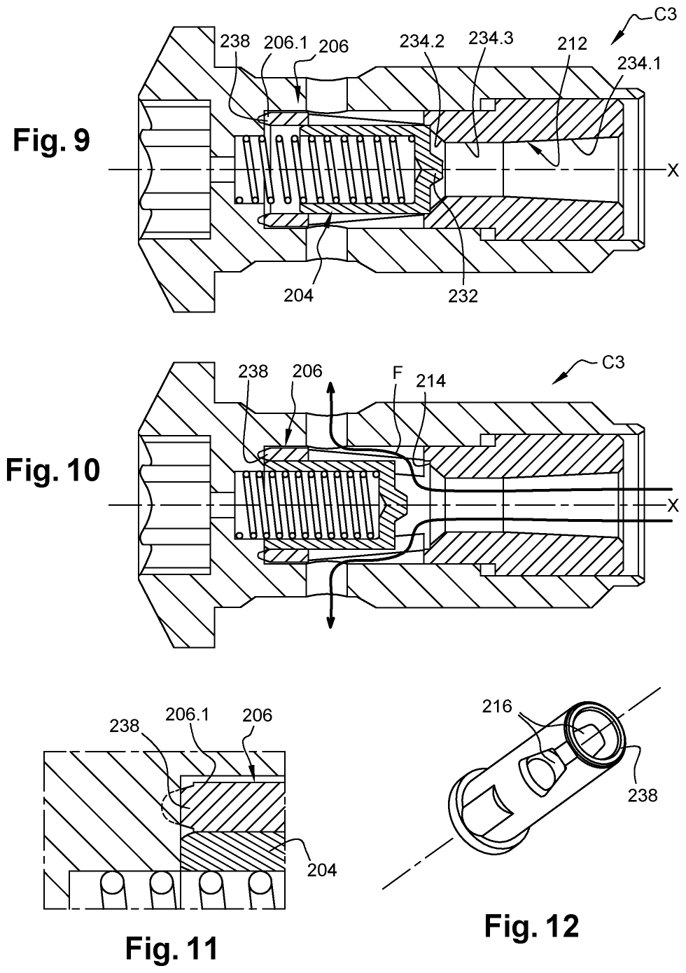

In FIGS. 9 to 12, another example embodiment of a piston valve C3 can be seen.

The valve C3 has a structure similar to those of the valves C1 and C2.

However, the valve C3 includes an obturator 204 the bottom of which is provided with a protrusion 232 oriented upstream, i.e., towards the end of the valve connected to the pressure source. The protrusion 232 has a frustoconical shape, the smallest base of which is oriented upstream. The effect of this protrusion is to divert the flow radially outwards, reducing the pressure drops.

Furthermore, the bore 212 of the interior element 206 includes a part 234 upstream of the valve seat 214 having a biconical form improving the dynamic flow of the fluid and minimising the pressure drops in the system. The part 234 includes a first zone 234.1 remote from the valve seat 214, the cross section of flow which decreases, a second zone 234.2 alongside the valve seat, the cross section of flow of which increases, and a third zone 234.3 with a constant cross section of flow connecting the first zone 324.1 and the second zone 234.2. In a variant, the zone 234.3 with constant cross section may be omitted.

Furthermore, the first end 206.1 of the interior element 206 includes an end face 236 perpendicular to the longitudinal axis and provided with an annular rim 238 in contact with the bottom of the envelope 203. The rim 238 is crushed when the interior element is mounted in the envelope 203, in particular during crimping. The rim 238 provides the fluidtightness between the envelope and the interior element. In FIG. 11, the rim 238 can be seen before crushing (in broken lines) and after crushing.

In this example, the windows 216 also have a trapezoidal shape with the largest base oriented upstream (FIG. 12).

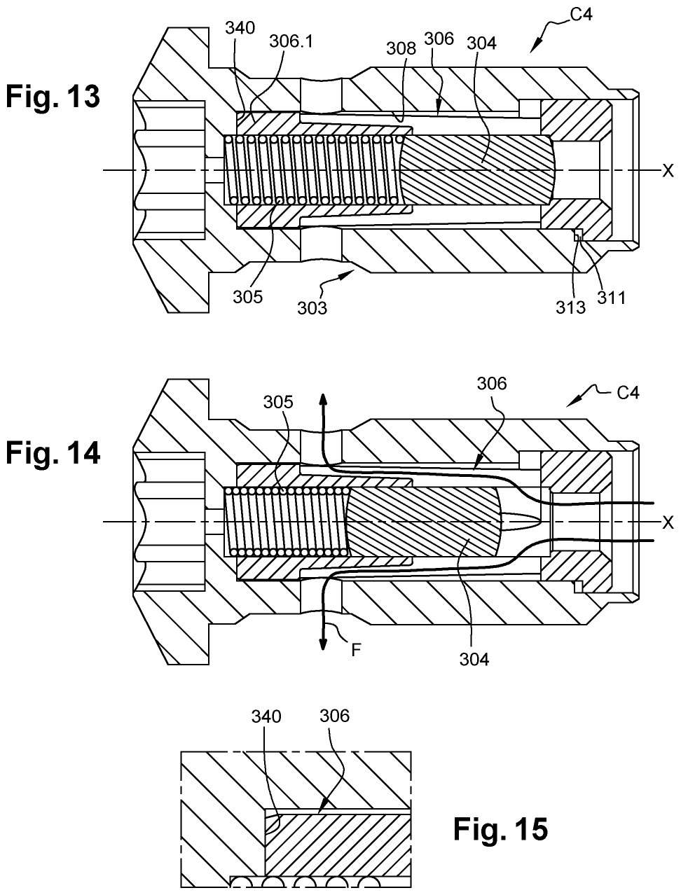

In FIGS. 13 to 16, another example of a piston valve C4 can be seen.

The valve C4 has a structure similar to those of the valves C1, C2 and C3.

The valve C4 differs from the valves C1, C2 and C3 in that the obturator 304 is a pin. The cost of the valve is reduced.

Furthermore, in this example, the interior element comes into abutment against the bottom of the bore 308 without deformation. The first end 306.1 of the interior element 306 includes a planar face 340 perpendicular to the axis X and comes into planar abutment against the bottom of the bore 308, providing the fluid-tightness. For this purpose, the positioning of the shoulder 311 is such that it does not come into contact with the annular surface 313. The fluid-tightness is achieved between the lateral wall of the interior element and the envelope 303.

In this example, when the valve C4 is open, the axial stop on the obturator 304 is obtained when the turns of the spring 305 are contiguous (FIG. 14).

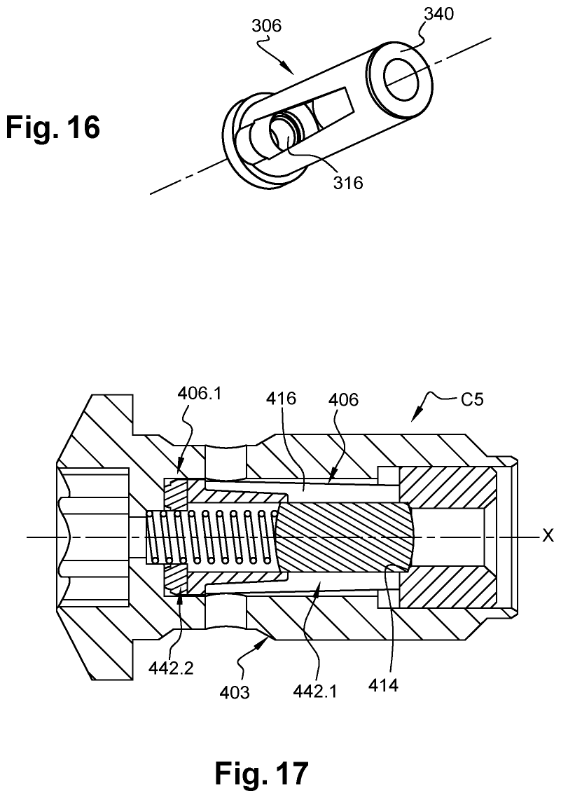

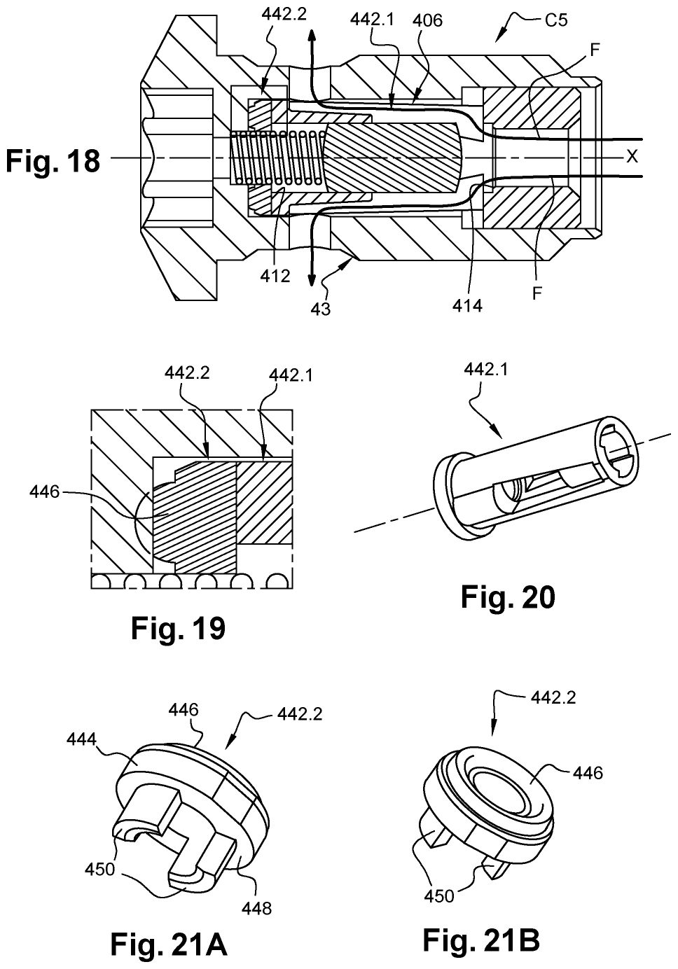

In FIGS. 17 to 21B, another example of a piston valve C5 can be seen.

The valve C5 has a structure similar to those of the valve C4.

The valve C5 differs from the valve C4 in that it makes it possible to protect the spring by avoiding the turns being contiguous when the valve is open.

The valve C5 includes an interior element 406 comprising a first part 442.1 carrying the valve seat 414 and the windows 416 and a second part 442.2 forming the first end 406.1 of the interior element 406 configured to come into contact with the bottom of the envelope 403.

In FIG. 20, the first part 442.1 can be seen, shown alone, and in FIGS. 21A and 21B the second part 442.2 can be seen, shown alone. It includes an annular piece 444 including a face 446 provided with a rim or annular protrusion intended to come into contact with the bottom of the bore, and a second face 448 opposite to the face 446, intended to come into abutment against a longitudinal end of the first part 442.1. The second face includes fingers 450 extending axially and intended to enter the bore 412 of the first part. The fingers 450 have an exterior lateral face in the form of an arc of a circle with a radius of curvature corresponding substantially to the radius of curvature of the bore 412. The fingers 450 provide a mounting by clamping of the second part 442.2 in the first part 442.1. Preferably the fingers 450 are preferably diametrically opposed.

The first and second parts are produced from the same material or different materials, for example the second part is produced from a more flexible material to confirm the fluid-tightness.

The various examples of a valve C1 to C4 are not exclusive of each other and may be combined, for example the valve C1 may include an obturator formed by a pin. Moreover, the interior element of the valve C3 may be produced in two parts made from different materials, in a similar manner to the interior element of the valve C5. The part intended to provide the fluid-tightness is produced from more flexible material. It should be noted that, in the valve C3, the second part does not fulfil the function of stop for the obturator. The second part is for example produced by coextrusion with the first part.

In the examples described, the windows extend axially, in a variant the windows are portions of a helix.

The piston valve according to the invention is adapted to control the supply of pressurised fluid in any hydraulic or pneumatic circuit, in particular in the automobile field. The piston valve according to the invention is particularly adapted for implementing cooling nozzles, in particular nozzles of the screw valve type, for internal combustion engines, more particularly for piston cooling.

1-24. (canceled)

25. A piston valve for hydraulic or pneumatic circuit comprising a hollow body of a longitudinal axis, a first longitudinal end of which is closed off by a bottom and a second longitudinal end of which is configured to be connected to a pressurised fluid source, comprising at least one fluid outlet orifice, a valve seat between the second longitudinal end of the hollow body and said at least one fluid outlet orifice, an obturator having a form that is cylindrical of revolution, cooperating with the valve seat, and a return spring of the obturator in abutment against the valve seat,
wherein the hollow body comprises an envelope at least partially forming an outside of the hollow body and an interior element at least partially forming an inside of the hollow body and mounted in the envelope in fluid-tight contact with the envelope,
wherein the envelope comprises said at least one fluid outlet orifice and a vent, and the interior element comprising a bore, an interior face of the bore comprising a first part at the second longitudinal end of the hollow body and a second part at said at least one fluid outlet orifice, the first part and the second part being connected at the valve seat, and
the second part provides a translational guidance of the obturator along the longitudinal axis and comprises at least one window extending axially so as to provide a channel for a fluid between the envelope and the obturator enabling the fluid to flow from the first part as far as said at least one fluid outlet orifice when the obturator is detached from the valve seat, and wherein the bottom is in a single piece with the envelope.

26. The piston valve of claim 25, wherein the interior element is made from a thermoplastic material.

27. The piston valve of claim 25, wherein the hollow body comprises a first fluid-tight contact between a first longitudinal end of the interior element and the bottom of the envelope, and a second fluid-tight contact between a second longitudinal end of the interior element and a second longitudinal end of the envelope located at the second longitudinal end of the body.

28. The piston valve of claim 27, wherein the first fluid-tight contact is a cone-on-cone contact or a planar abutment orthogonal to the longitudinal axis.

29. The piston valve of claim 28, further comprising at least one of the following: the first longitudinal end of the interior element comprises at least one annular rim in contact with the bottom of the envelope; and the second fluid-tight contact is a planar abutment contact normal to the longitudinal axis.

30. The piston valve of claim 25, wherein the return spring is a helical spring; wherein the obturator comprises a hollow body closed at one end configured to come into contact with the valve seat; and wherein a longitudinal end of the return spring is mounted in the obturator.

31. The piston valve of claim 25, wherein the bottom comprises a recess housing a longitudinal end of the return spring.

32. The piston valve of claim 25, wherein each window comprises a zone opposite a fluid outlet orifice.

33. The piston valve of claim 25, further comprising n fluid outlet orifices and n windows, n being greater than or equal to 1.

34. The piston valve of claim 33, wherein the n fluid outlet orifices are piercings and wherein each window has a cross section equal to a diameter of a fluid outlet orifice.

35. The piston valve of claim 25, further comprising an angular aligner to angularly orient the interior element with respect to the envelope so that a zone of said at least one window is opposite said at least one fluid outlet orifice.

36. The piston valve of claim 35, further comprising forms on the envelope and the interior element cooperating so as to impose a given angular position on the interior element with respect to the envelope.

37. The piston valve of claim 25, wherein the interior element is held in the envelope by crimping.

38. A pressurized fluid circuit comprising a pressurized fluid source and at least one piston valve of claim 25, wherein the first longitudinal end is connected to the pressurized fluid source.

39. The pressurized fluid circuit of claim 38 forming a hydraulic circuit of an internal combustion engine.

40. A nozzle to cool a piston of an internal combustion engine comprising at least one piston valve of claim 25 and at least one tube configured to guide the fluid from said at least one fluid outlet orifice towards the piston.

41. The nozzle of claim 40, wherein the envelope comprises an external thread to mount in an engine block.

42. A method for manufacturing a piston valve of claim 25, comprising:
manufacture of the envelope,
manufacture of the interior element,
introduction of the interior element into the envelope from an end of the envelope configured for an entry of the fluid, and
immobilization of the interior element in the envelope.

43. The manufacturing method of claim 42, further comprising at least one of the following:
the envelope being produced by cold stamping and re-machining;
the interior element being produced by thermoplastic injection molding; and
the interior element being immobilized in the envelope by crimping.

44. The manufacturing method of claim 42, wherein the interior element is immobilized in the envelope by crimping and, during crimping, the interior element is put under axial strain in the envelope.
